(19) United States
(12) Patent Application Publication
(10) Pub. No.: US 2025/0199751 A1
(43) Pub. Date: Jun. 19, 2025

(54) DIGITAL SIGNAGE STAND

(71) Applicant: Ardalan AFSHAR, Los Angeles, CA (US)

(72) Inventor: Ardalan AFSHAR, Los Angeles, CA (US)

(21) Appl. No.: 18/984,616

(22) Filed: Dec. 17, 2024

Related U.S. Application Data
(60) Provisional application No. 63/611,150, filed on Dec. 17, 2023.

(51) Int. Cl. G06F 3/147; G06F 3/01; G06F 3/044

(52) U.S. Cl. CPC G06F 3/147; G06F 3/011; G06F 3/044

(57) ABSTRACT

A digital signage stand can include a main body having a display area outwardly oriented and a display device positioned on the stand main body. A processor can be connected to a display component and positioned within the display area. The processor can receive, without user input, an instruction to change content displayed at the display component. The processor can also change the content displayed at the display component based on the instruction. The digital signage stand can also include a power supply component, electrically connected to the display component and the processor.

### RELATED APPLICATION(S)

This application claims priority to and the benefit of U.S. Provisional Application No. 63/611,150, filed Dec. 17, 2023, titled “Digital Signage Valet Stand,” which is hereby incorporated by reference.

### DESCRIPTION OF THE RELATED ART

Valet stands, podiums, etc. can be used in various activities to provide a centralized place for users to interact. For example, valet stands can be utilized by operators of a valet service to facilitate vehicle drop-off and pick up. Such stands, podiums, etc. can receive significant interaction and/or attention from others, either by those using services associated with the stand or podium, or simply by being in the vicinity of the stand or podium.

### SUMMARY

In some aspects, the techniques described herein relate to a digital signage stand including: a main body including a display area outwardly oriented; and a display device positioned on the stand main body and including: a processor; a display component connected to the processor and positioned within the display area; a non-transitory machine-readable medium storing instructions which, when executed by the processor, cause the processor to perform operations including: receiving, without user input, an instruction to change content displayed at the display component; and changing the content displayed at the display component based on the instruction; and a power supply component, electrically connected to the display component and the processor.

In some aspects, the techniques described herein relate to a digital signage stand, wherein the digital signage stand is configured as a parking valet stand, the main body including an upright desk with a tabletop.

In some aspects, the techniques described herein relate to a digital signage stand, wherein the display component includes a display panel and a touch panel, the touch panel overlaying the display panel.

In some aspects, the techniques described herein relate to a digital signage stand, wherein the display component further includes a heat-insulating component positioned between the touch panel and the display panel.

In some aspects, the techniques described herein relate to a digital signage stand, wherein the touch panel includes a touch function substrate and a protective cover, the protective cover overlaying the touch function substrate.

In some aspects, the techniques described herein relate to a digital signage stand, wherein the touch panel utilizes capacitive touch technology, and screen resolution of the display panel is 4K or higher.

In some aspects, the techniques described herein relate to a digital signage stand, wherein the display device includes a frame, and the frame is positioned around a periphery of the display component and is made of brushed aluminum material.

In some aspects, the techniques described herein relate to a digital signage stand, wherein the power supply component includes a battery.

In some aspects, the techniques described herein relate to a digital signage stand, wherein the power supply component further includes a solar panel connected electrically to the battery.

In some aspects, the techniques described herein relate to a digital signage stand, wherein the display device additionally includes a wireless transmission component which is connected to the processor, and the wireless transmission component utilizes Wi-Fi, Bluetooth, or Zigbee communication formats.

In some aspects, the techniques described herein relate to a digital signage stand, wherein the wireless transmission component is connected to a remote platform, and the remote platform allows the changing and/or managing of the content.

In some aspects, the techniques described herein relate to a digital signage stand, wherein the remote platform allows a user to remotely control or change the content displayed.

In some aspects, the techniques described herein relate to a digital signage stand, wherein the remote platform wirelessly communicates with one or more digital signage stands and allows a user to remotely control or change the content displayed on the one or more digital signage stands independently of each other.

In some aspects, the techniques described herein relate to a digital signage stand, wherein the display device further includes a near-field communication component which is connected to the processor.

In some aspects, the techniques described herein relate to a digital signage stand, wherein the display device further includes a voice recognition unit which is connected to the processor, enabling voice recognition execution and generating corresponding commands for the processor.

In some aspects, the techniques described herein relate to a digital signage stand, wherein the display device additionally includes an augmented reality unit which is connected to the processor, wherein the augmented reality (AR) unit transmits instructions to augmented reality enabled devices to provide AR content related to the content as part of an augmented reality image.

In some aspects, the techniques described herein relate to a digital signage stand, wherein the instruction is based on a time.

In some aspects, the techniques described herein relate to a digital signage stand, further including a positioning unit, the operations further including generating of a location of the digital signage stand, wherein the instruction is based on the location of the digital signage stand.

In some aspects, the techniques described herein relate to a digital signage stand, the operations further including: determining a time at the location of the digital signage stand; and generating the instruction based at least on the time.

In some aspects, the techniques described herein relate to a digital signage stand, wherein the display device further includes a sensing component which is connected to the processor.

In some aspects, the techniques described herein relate to a digital signage stand, wherein the sensing component includes one or a combination of a dynamic image sensor, a static image sensor, and a sound capturer.

In some aspects, the techniques described herein relate to a digital signage stand, wherein the sensing component includes an analysis unit for analyzing user information, the operations further including: generating user information based on sensed data obtained from the sensing component; obtaining an analysis result from an analysis unit analyzing the user information; and dynamically adjusting the content displayed by the display component based on the analysis result.

In some aspects, the techniques described herein relate to a digital signage stand, the operations further including determining, from at least the sensed data, the user information that includes a dwell time based on a duration of detection and a proximity to the digital signage stand of the user.

In some aspects, the techniques described herein relate to a digital signage stand, the operations further including: determining dwell times for a plurality of users; determining an average dwell time or a median dwell time based on the dwell times; and automatically changing the content at the display device when the average dwell time or the median dwell time is below a predetermined threshold dwell time.

In some aspects, the techniques described herein relate to a digital signage stand, wherein the processor of the display device is additionally connected to an analysis platform that analyzes user information to generate an engagement result.

In some aspects, the techniques described herein relate to a digital signage stand, the operations further including: generating modified sensed data with an onboard processor that in communication with the analysis unit; and causing transmission, via the onboard processor, of the modified sensed data to a remote platform.

In some aspects, the techniques described herein relate to a digital signage stand, the operations further including: determining a location of the digital signage stand; determining a composition of users proximate to the sensing component, the composition including identifying information for one or more of the users; transmitting the composition to a remote platform that analyzes the composition; receiving display instructions from the remote platform based on the analyzed composition; and displaying, at the display component, the content based at least on the display instructions.

In some aspects, the techniques described herein relate to a digital signage stand, wherein the sensing component is a light sensor and the operations further include changing the content based on an ambient light level at the digital signage stand.

In some aspects, the techniques described herein relate to a digital signage stand, wherein the display device further includes a language-switching unit which is connected to the processor, the language-switching unit enables the language of the content or the functional interface of the display device to be manually switched.

In some aspects, the techniques described herein relate to a digital signage stand, wherein the display device further includes a language-switching unit and a positioning unit, the language-switching unit and the positioning unit are respectively connected to the processor via telecommunication, allowing the language of the content or the functional interface language of the display device to be switched based on manual switching or geographical location of the digital signage stand.

### BRIEF DESCRIPTION OF THE DRAWINGS

The disclosure will now be described, by way of example, with reference to the accompanying drawings, in which:

FIG. 1 is a schematic diagram of the structural design of the digital signage stand in a first embodiment of the disclosure;

FIG. 2 is a block diagram of the digital signage stand in the first embodiment of the disclosure;

FIG. 3 is a schematic diagram of the display component structure in the first embodiment of the disclosure;

FIG. 4 is a block diagram of the digital signage stand in a second embodiment of the disclosure;

FIG. 5 is a block diagram of the digital signage stand in a third embodiment of the disclosure;

FIG. 5A is a block diagram of an example system architecture and operations of a digital signage stand.

FIG. 6 is a block diagram of the digital signage stand in a fourth embodiment of the disclosure;

FIG. 7 is a block diagram of the digital signage stand in a fifth embodiment of the disclosure;

FIG. 8 is a block diagram of the digital signage stand in a sixth embodiment of the disclosure;

FIG. 9 is a block diagram of the digital signage stand in a seventh embodiment of the disclosure;

FIG. 10 is a block diagram of the digital signage stand in an eighth embodiment of the disclosure;

FIG. 11 is a block diagram of the digital signage stand in a ninth embodiment of the disclosure; and

FIG. 12 is a block diagram of the digital signage stand in a tenth embodiment of the disclosure.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” The specific devices and processes illustrated in the attached drawings, and described in the following specification, are simply exemplary embodiments. Any implementation described herein as “exemplary” or “illustrative” is not necessarily to be construed as preferred or advantageous over other implementations. Hence, specific dimensions and other physical characteristics relating to the embodiments disclosed herein are not to be considered as limiting. Like reference numerals are intended to identify similar structural elements, portions, or surfaces used consistently herein.

While the following example embodiments and corresponding figures depict examples where a component or feature is cumulatively added to a preceding embodiment, such is intended to only provide a non-limiting examples of embodiments of increasing complexity rather than limiting the disclosure to only those combinations of elements. As such, the present disclosure contemplates that any of the disclosed features can be combined in numerous embodiments without any particular feature or component being deemed essential for inclusion.

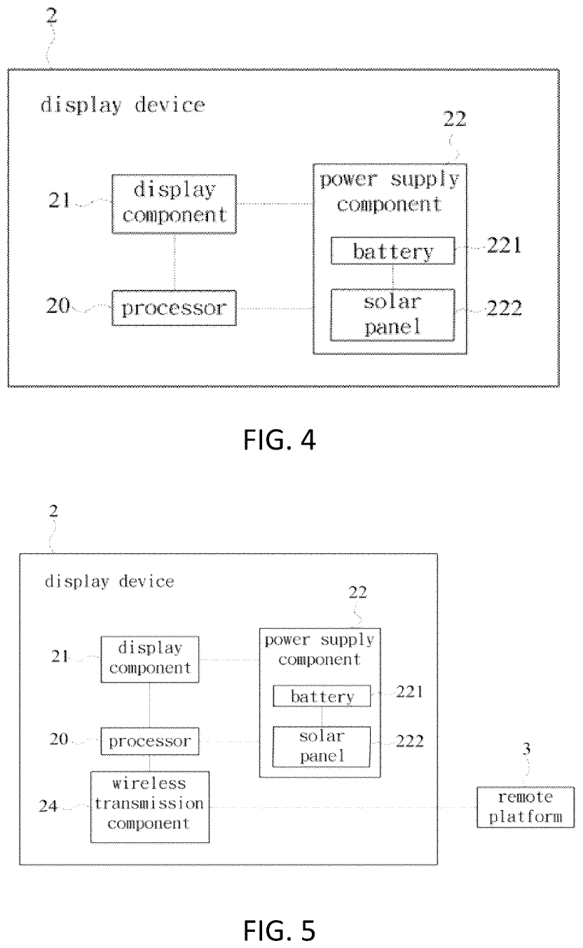

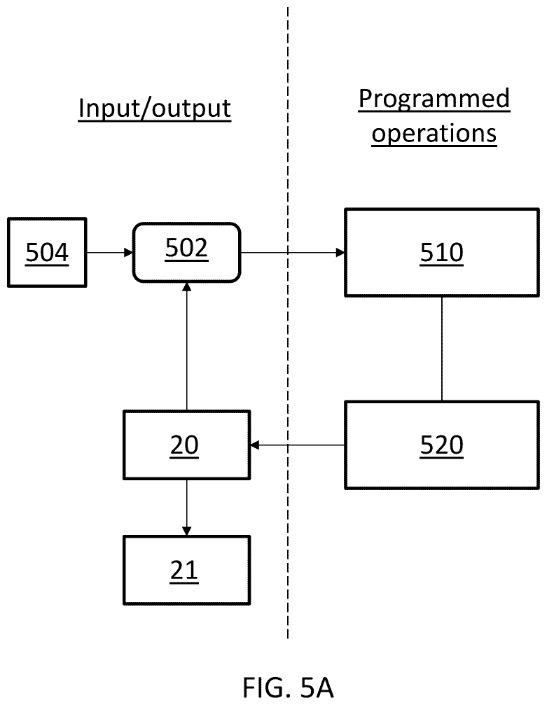

As one specific example described in further detail herein, FIG. 3 depicts a power supply component (e.g., AC and/or DC power such as from a wall outlet or generator). FIG. 4 describes that the power supply component can include a solar panel and battery. FIG. 5 expands on FIG. 4 to include a wireless transmission component. However, the present disclosure does not require such combinations, and thus, in this example, contemplates an embodiment with having a wireless transmission component but that may not include the solar panel and/or battery. The present disclosure thus provides the skilled person with the guidance needed for constructing many embodiments combining any of the disclosed features.

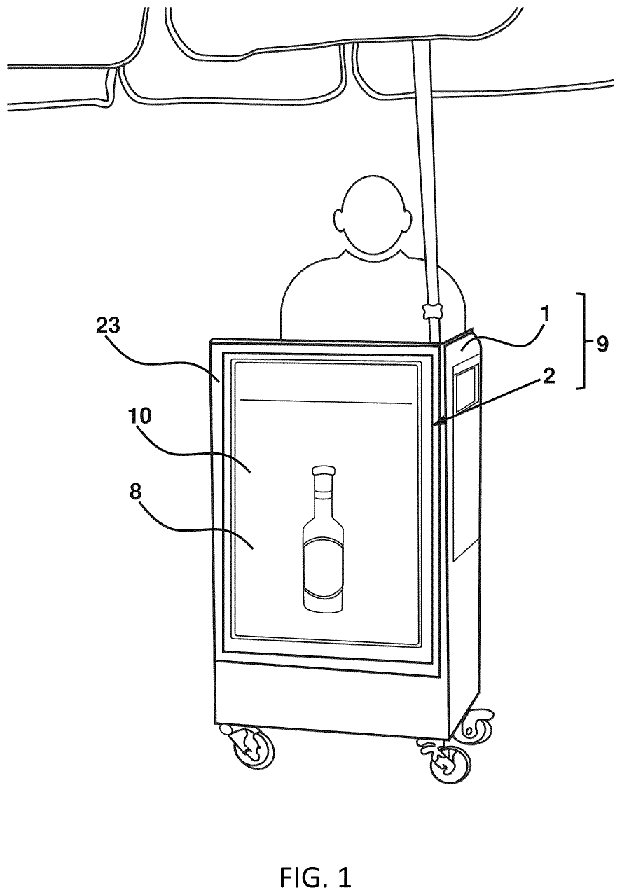

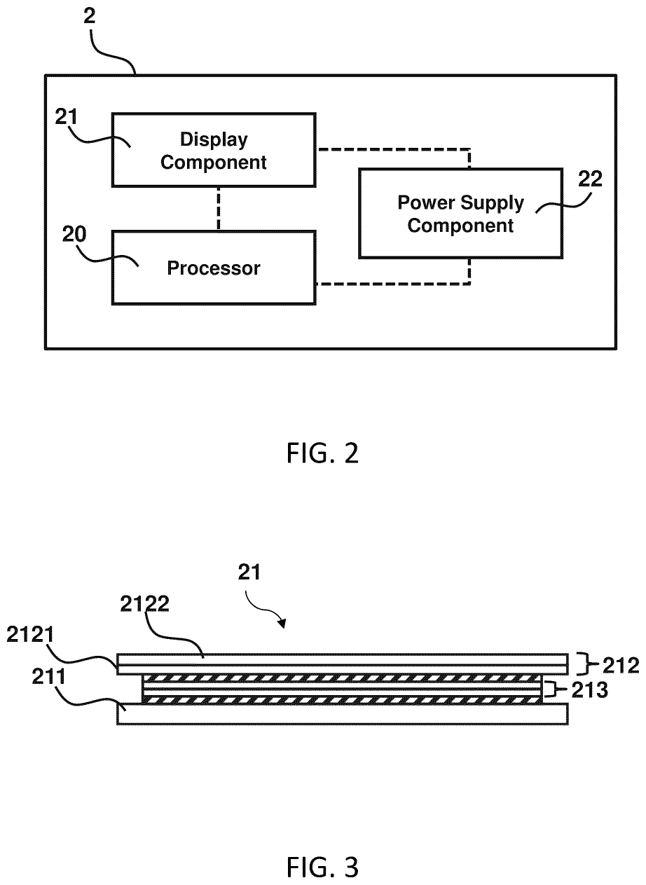

FIGS. 1 to 3 depict an exemplary physical structure (FIG. 1), block diagram (FIG. 2), and display component (FIG. 3) of a first embodiment of the digital signage stand. As used herein, the term “component” is synonymous with “module” or “system,” and can include one or more hardware device and/or software modules. FIG. 1 depicts digital signage stand 9 which can be utilized for placement at various venues, such as restaurants, hotels, exhibition halls, event venues, etc. The digital signage stand 9 can include a main body 1 and a display device 2.

Main body 1 can specifically be an upright desk with a tabletop for staff to perform operations such as registration, item placement, and managing personnel and vehicle entries and exits. Main body 1 can have display area 10 oriented outwardly. The display device 2 can be positioned on main body 1 and can include processor 20, display component 21, and power supply component 22. Display component 21 can be connected to processor 20 for telecommunication and positioned within display area 10 to display content 8. Power supply component 22 can be electrically connected to display component 21, providing power.

The construction can include aluminum as a lightweight and sturdy material, wheels outfitted with solid tires with rugged treads to accommodate rough ground surfaces outdoors, and power supply component 22 including a long-runtime battery to enable free repositioning of the digital signage stand 9 as needed.

In various embodiments, particularly (but not exclusively) embodiments where the digital signage stand is designed as a kiosk or valet stand, one or more of the features below can be included, in any combination.

Digital signage stand 9 can have optimized weight distribution for stability. Digital signage stand 9 can include having a weight distribution of components that allow it to stand alone securely and without being affixed or mounted to a wall, floor, etc. In this way, such a balanced digital signage stand 9 can enhance its mobility, particularly when combined with battery operation and the addition of wheels to main body 1. By having the components balanced, this can improve stability without adding significant weight or bulk. For example, power supply component (e.g., a battery), processor 20 (and its attendant other computing hardware), display component 21, etc. can have a configuration that locates one or more components within or upon main body 1 to provide a substantially balanced configuration (e.g., having a center-of-gravity) be approximately inline with the center of the base and/or wheels (if present). Various embodiments can have some variation in the exact location of the center of gravity, but can include, for example, being less than 1%, 5%, 10%, etc. off of a longitudinal (e.g., vertical) axis of main body 1. In some embodiments, either additionally or alternatively, the distribution can be such that the center of gravity is lower, making digital signage stand 9 less top-heavy. For example, this can include the components being disposed such that the center of gravity is in the lower 50%, 25%, 10%, or even 5% of the height of digital signage stand 9. In some embodiments, this can include an aluminum frame (e.g., of main body 1) being counterbalanced as a result of the component distribution.

Digital signage stand 9 can have a compact, space-efficient design. The components of digital signage stand can be space-optimized to have a reduced profile, which can facilitate placement in high-traffic areas.

Digital signage stand 9 can include a seamless integration of a digital display. For example, display component 21 can be seamlessly embedded into the cabinet design, and in some embodiments can be arranged or oriented to maximize screen visibility at an optimal eye level.

Digital signage stand 9 can include hidden cables and power management. in some embodiments, substantially (or completely) all power and connectivity components can be located internally, which can reduce the risk of damage or tampering.

Digital signage stand 9 can include components that are lightweight and modular. For example, various combinations of the disclosed components can be separable for ease of transport and then later assembled.

Digital signage stand 9 can include weather-resistant and durable materials. Such materials can include aluminum, strong plastics, etc. to provide additional stability against the elements.

Digital signage stand 9 can include enhanced security features such as tamper-proof locks (e.g., on compartments or hardware access panels), reinforced panels, and secure access points to protect its hardware and content.

Digital signage stand 9 can include customizable exterior panels that can include additional physical (e.g., poster or picture) slots or digital (e.g., electronic display panels or screens) panels in addition to display component 21, which may be the main display located at the front of digital signage stand 9.

Digital signage stand 9 can include energy-efficient technology integration such as energy-efficient cooling systems, low-power LCD displays, and software-optimized power usage.

Thus, the digital signage stand 9 can integrate digital display technology, along with any of the other disclosed features, into the main body structure, creating a modern and innovative device that optimizes the display and communication effectiveness of content displayed at display component 21. In some embodiments, content 8 can be static images, dynamic videos, or interactive multimedia. Content 8 can be electronically updated to be tailored to the attributes of a displayed product, user needs, or demographic characteristics of the location where digital signage stand 9 is placed.

As used herein, the term “user” includes any person interacting with any component of the system. Users can include people directly interacting with the system (e.g., using a touch screen to make selections or get information). Users can also include operators of the system (e.g., an employee utilizing a kiosk embodiment, a person remotely updating the system or its content, etc.). Users can also include people nearby that can potentially influence the content displayed or have data collected about them. Such users can be people passing by, looking at digital signage stand 9 but not directly interacting with it, incidental persons in the background or otherwise sufficiently proximate to be detected by any integrated sensors, etc.

In some embodiments, display device 2 can be operated through a controller or by displaying relevant function menus through display component 21. Display component 21 can be an item with touch functionality, for example, by including display panel 211 and touch panel 212. Touch panel 212 can be overlaid on display panel 211, providing touch control capabilities allowing users to interact with content 8, including accessing additional information, directly booking services or purchasing products from display component 21. In an embodiment, touch panel 212 can use capacitive touch technology, and the screen resolution of the display panel 211 can be 4K or higher, providing a fast touch response mechanism with advanced screen technology specifications. Additionally, display component 21 can have automatic brightness adjustment or anti-reflective functionality to facilitate clear visibility under various lighting conditions. The interface (e.g., touch screen or voice-controlled) of the content 8 can be designed to be intuitive and user-friendly, and specific menus and options can be designed for people with disabilities.

Display component 21, may include a heat-insulating component 213 positioned between the touch panel 212 and the display panel 211. Heat-insulating component 213 can improve the tolerance of the display component 21 to temperature changes, which can be particularly important for outdoor products. Within this, heat-insulating component 213 can be composed of materials capable of reflecting infrared rays and anti-fog film materials. The reflecting material can act to reduce the internal temperature of display component 21. Simultaneously, when present, the anti-fog film materials can reduce the temperature difference between the inside and outside of the display component 21 from causing fogging of surfaces that might affect the clarity of content shown at display panel 211. Heat-insulating component 213 can, for example, be fixed between touch panel 212 and display panel 211 using, for example, optical adhesive as a fixing component. Additionally, touch panel 212 of display component 21 can include a structure consisting of touch function substrate 2121 and protective cover 2122. Protective cover 2122 can be overlaid on touch function substrate 2121 to provide necessary protection, such as isolating external humidity and preventing damage from UV radiation. Various films, such as anti-glare films and diffusion films, can be coated, attached, or applied to protective cover 2122 to enhance display performance. Through these designs, display component 21 exhibits improved durability while maintaining visibility.

Furthermore, display device 2 can be assembled in display area 10 of main body 1 or embedded in display area 10 to maintain a flat surface with the display component 21. In various embodiments, display area 10 can include the front facing (e.g., towards a potential viewer) surface of main body 1. As used herein, the “front surface” is depicted in FIG. 1 with content 8 being displayed outwardly. In other embodiments, additional display devices can be provided on any suitable surface, e.g., the sides, the desktop, the rear (e.g., for use by the depicted operator), etc. Display device 2 can include frame 23, which can be positioned around the perimeter of display component 21. In some embodiments, frame 23 can include durable materials such as brushed aluminum, hard plastic, or other material that can optionally be flexible and lightweight. Frame 23 can provide excellent stability and usability, while additional surface treatments (e.g., coatings) can be applied to enhance its resistance to environmental effects.

FIG. 4 depicts a block diagram for a second embodiment of the digital signage stand. In some embodiments, digital signage stand 9, having power supply component 22 of the display device 2, can include battery 221. This can allow display device 2 to operate without the need for external power. In some embodiments, battery 221 can be a lithium battery, providing power over long use times (e.g., 1-24 hours, 1-7 days, etc.) for supporting uninterrupted operation. Additionally, power supply component 22 can include solar panel 222 connected electrically to battery 221 or more generally to digital signage stand 9. Solar panel 222 can be embedded on the main body 1, configured on the display device 2, attached on a side, top, or above the main body, etc., to receive solar energy at any time for conversion and storage. Solar panel can also be a peripheral component that can be located nearby but not necessarily mounted to main body 1.

FIG. 5 is a block diagram for a third embodiment of the digital signage stand. Display device 2 can further include wireless transmission component 24, which can be connected to processor 20 for telecommunication. As used herein, the term “telecommunication” refers to any form of electronic communication, such as wired or wireless data transfer, including internet connectivity. The wireless transmission component 24 can utilize Wi-Fi, Bluetooth, Zigbee, etc. communication formats to provide information connectivity, utilizing advanced security protocols to protect data transmission security. Wireless transmission component 24 can be an additional modular structure, allowing attachment of network peripherals based on user needs. For example, wireless transmission component 24 can have one or more ports for physical connection to processor 20 of display device 2. Moreover, wireless transmission component 24 can be connected to remote platform 3, which can allow changing, updating, and managing of content 8. Remote platform 3 can be, for example, a server, a local computer, a laptop computer, a mobile computer, a smartphone, etc., where remote platform 3 can be in electronic communication with wireless transmission component 24. In some embodiments, there can also be a wired connection, allowing local-area-network (LAN) connectivity. Through remote platform 3, instantly or at prescribed times, content 8 can remotely be updated, modified, or changed at display component 21. This can enable real-time adjustment of content 8. In some embodiments, remote platform 3 can wirelessly communicate with one or more digital signage stands and allow a user to remotely control or change content 8 displayed on the digital signage stands independently of each other. Similarly, content 8 can be changed substantially simultaneously at multiple digital signage stands to allow dynamic and efficient updating of content at multiple locations with a reduced number of commands or instructions.

FIG. 5A is a block diagram of an example system architecture and operations of the digital signage stand. The digital signage stand can be configured to at 510, receive, without user input, an instruction 502 to change content displayed at the display component. Such automated changing of content 8 can reduce the overhead of user control and also allow automated scheduled changes to content 8. The contemplated providing of instructions without user input can also, in some cases, be broadened to include allowing for limited or reduced user input. For example, a user may configure or set the system to utilize a schedule of content changes, and after that the system can execute the changes with little or no further user input until desired. Similarly, user input can be implemented as desired to override or adjust what can otherwise be automated changes. For example, if in response to updating content based on time of day a user elects to not allow this change or prefers a different one, the system can be configured to allow the user to provide user input as part of the content changing. The system can be configured for manual or automated reprogramming of content 8 in real-time responsive to time-sensitive conditions, varying durations for particular displays of content 8, or to facilitate unplanned alteration of content 8. Additionally, the user derives the benefit from the system's capabilities for on-the-fly reconfiguration of the content 8 presentation following an evaluation of the form and sequence of the programming via direct user observation or remote monitoring where content 8 can also be displayed, mirrored, or reproduced at remote platform 3.

At 520, content 8 displayed at the display component can be changed based on the instruction. Instruction 502 described above can include electronic instructions that can be generated by one or more software programs, for example based on analysis of user interaction or responsive to other conditions such as time, location, sensed data, etc. Instruction 502 can be input from an external computer 504, processor 20, etc. The programmed operations 510 and 520 depicted in FIG. 5A can be performed by any suitable processor including processor 20, processors on external computers, etc. The changing performed by processor 20 can be performed by, for example, accessing premade digital content which can be stored in local memory, downloaded from remote platform 3, streamed from online servers, dynamically generated by processor 20 based on user engagement or sensed data, etc. Processor 20 can cause the changed content 8 to be displayed at display component 21.

The instruction can include external content generated outside the computing system from one or more authorized sources, for example, authorized affiliates providing supplemental content. The supplemental content can be merged into content 8, optionally also on the basis of predefined formatting or placement rules. In some embodiments, the inclusion of external content into content 8 can be performed without prior intermediate delivery to a user and instead received and merged according to the predefined rules. In another embodiment, the displaying of content 8 can incorporate visual or informational elements not generated by the user, such as public data that can be scraped or otherwise obtained, e.g., via network connectivity with an electronic public data source. In various embodiments, the published format and layout of the public data integrated into content 8 can include data inserted into software-defined placeholders established in advance by user control.

Furthermore, such automated content changes can interface with analysis done of user traffic, engagement (e.g., interacting with a touch screen), user selections (e.g., what might be selected via touch screen or voice commands), artificial intelligence analysis (e.g., predicting what kinds, formats, durations, or other settings may increase user engagement or certain selections), etc.

To provide a tailored user-experience (e.g., a user is sensed by one or more sensors of the system or otherwise in communication with the system, is identified or has identifying information about them generated, and targeted content is displayed), the system may initiate the analysis either by local processing (e.g., by an analysis unit) or by uploading of sensor data (e.g., user detection, number of users, nearby object detection such as vehicles, sensor data formatted to be input for a machine learning algorithm such as pixel arrays, etc.), logs, telemetry (e.g., a handshake or other assessment of communication, on/off status of sensors or other hardware components, errors, etc.), etc. over a network to remote platform 3 for interpretation. For established patterns of unique-user data retention digital signage stand 9 can perform kiosk functions such as the display of a queue number, entry time record, account balance, or relevant transaction prompt corresponding to the profile record that matches a supplied identifier (e.g., physical credit cards or credit card numbers, paper receipts, lookup code, phone number, wi-fi MAC address, NFC wallet, or any other embodiment of establishing a relationship between people/users outside the system to a database with relevant information about the people/users that the system can access. In some embodiments, digital signage stand 9 can be configured to show matrix barcodes (e.g., a QR code) or access temporary bidirectional network connections (e.g., ad-hoc wireless connections) during transactions external to the device (e.g., managing inventory, payment functionality, logging transactions, etc.).

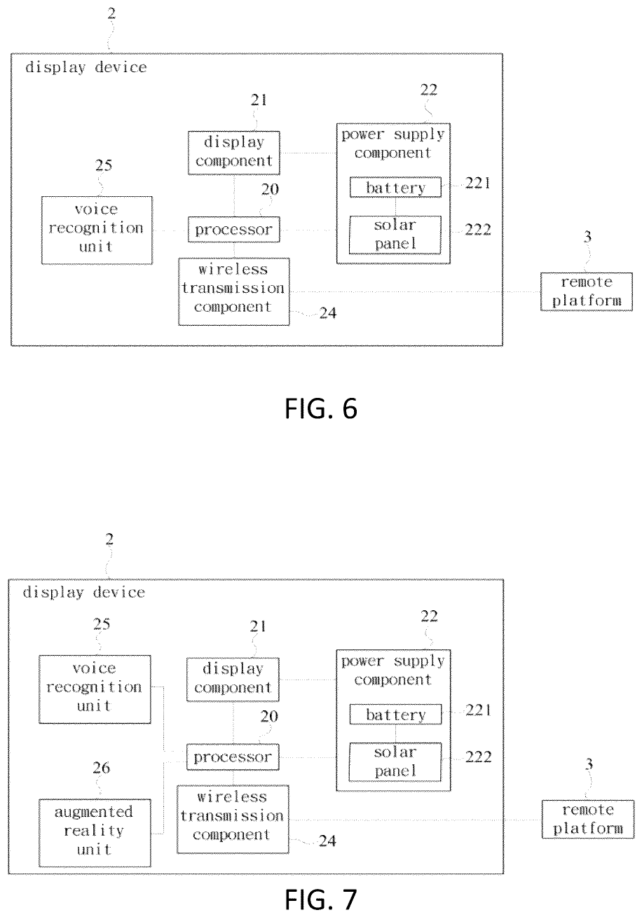

FIG. 6 is a block diagram for a fourth embodiment of the digital signage stand. Display device 2 may further include voice recognition unit 25, which can be connected to the processor 20 for telecommunication to execute voice recognition, enabling the processor 20 to generate corresponding commands. Voice recognition unit can include hardware such as one or more microphones and associated software modules to receive the electronical signals from the microphone and analyze them to detect voice commands and implement corresponding instructions. Through voice recognition unit 25, the public can interact with content 8 displayed at display device 2 through voice, or it can be used by administrators to control display device 2. After receiving and recognizing human speech, the voice recognition unit 25 sends can send recognition results to processor 20, allowing processor 20 to generate various commands based on the voice content. For example, if the voice recognition unit 25 receives content like “switch to the next one,” it can transfer the recognized result to processor 20, and processor 20 can generate a switching command causing display component 21 to change to other content 8. When content 8 involves interactive multimedia, such as a voting activity for multiple displayed options, when voice recognition unit 25 receives content like “I choose the left,” it can transfer the recognized result to processor 20. Processor 20 can generate a display state replacement command based on this result, increasing the vote count for the left product in the current content 8 displayed by the display component 21, producing corresponding animations, and so on.

FIG. 7 is a block diagram for a fifth embodiment of the digital signage stand. Display device 2 may further include an augmented reality (AR) unit 26, which can be connected to the processor 20 for telecommunication, to transmit instructions to augmented reality enabled devices to provide AR content related to content 8 as part of an augmented reality image. Through the augmented reality unit 26, the digital signage stand 9 can provide advanced interactive features, enhancing the user experience through augmented reality. Implemented AR extensions may include Internet links or promotions related to geo-location or specifically to content 8 being displayed in real-time, as well as supplementary notifications drawn from external data sources, for example, accessing social media feeds or public information data.

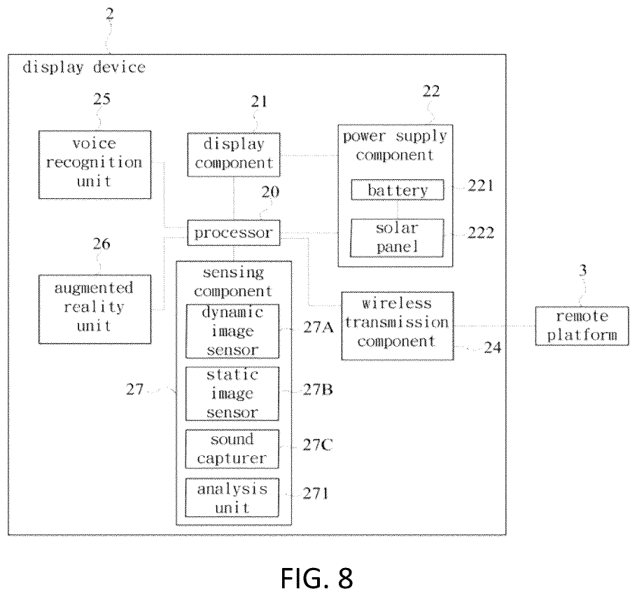

FIG. 8 is a block diagram for a sixth embodiment of the digital signage stand. To enhance the awareness and effectiveness of content dissemination for digital signage stand 9, display device 2 can include sensing component 27, which can be connected to the processor 20 for telecommunication, to detect the status of users passing by main body 1 and generate user information. Consequently, the management or advertising entity can organize and analyze the application effectiveness of digital signage stand 9, especially when the number of these digital signage stands 9 in use is substantial. Information collection can be comprehensive, including the geographical location of digital signage stand 9, playback time, content 8, and user feedback. User information may include age, gender, dwell time, interaction frequency, etc. of persons, objects, etc. that may be sensed by digital signage stand 9, and as such is not limited to users directly interacting with the system or already electronically associated with the system (e.g., authorized users, customers, etc.) User information can serve as a basis for the system causing changes of content 8 at display component 21. Sensing component 27 may include, for example, one or a combination of dynamic image sensor 27A, static image sensor 27B, and sound capturer 27C to obtain relevant information about these users.

Sensing component 27 may include analysis unit 271 to analyze the user information. Digital signage stand can be configured to generate user information based on sensed data obtained from sensing component 27 to obtain analysis results and enable the processor 20 to dynamically adjust the content 8 displayed by display component 21 based on the analysis result. After collecting user information, analysis unit 271 can perform real-time or periodic analysis, allowing processor 20 to adjust content 8 based on the analysis results. In some embodiments, this can include determining, from at least the sensed data, the user information that includes a dwell time based on a duration of detection and a proximity to the digital signage stand of the user. A dwell time can be, for example, the time a user is within 1 meter of the digital signage stand, 3 meters, etc. For example, when user information collected by sensing component 27 indicates that, during the time period from 11 AM to 1 PM, most users passing by digital signage stand 9 are females aged 30-50, with an average dwell time of only 15 seconds, this may suggest that content 8 is not capturing the interest of users. The processor 20 can then adjust the attributes of content 8 for the next display. Alternatively, when the analysis results show that most users do not linger in front of the digital signage stand 9, the processor 20 can change content 8 to test if it attracts more attention. The adjustment mode mentioned above is one example, and the actual settings can be made according to the needs of users and the installation locations of the digital signage stand 9. In some embodiments, dwell times can be determined for multiple users. Then, an average dwell time or a median dwell time can be determined based on the dwell times. Content 8 can be automatically changed at display device 2 when the average dwell time or the median dwell time is below a predetermined threshold dwell time (e.g., 15 seconds, 10 seconds, etc.).

In addition to profile statistics gathered from supplied user information, an interactive touchscreen, etc. digital signage stand 9 can include dynamic image sensor 27A (e.g., a webcam) to obtain images that can be utilized by analysis unit 271 to infer audience metrics for the physical vicinity of the digital signage stand 9, and in some embodiments specifically within an area in front of display component 21. In some embodiments, software can obtain webcam snapshots at predefined intervals (e.g., every second, 10 seconds, 15 seconds, 1 minute, etc.) to approximate the number of persons within the viewing distance of display component 21. In some embodiments, analysis unit 271 can base the determined approximation based on person height, generic body type, and motion-detection of indicia of persons (e.g., body shapes) as distinct from fixed background objects, moving vehicles, animals, etc. The collected snapshots can be provided to analysis unit 271 for correlation with user information and known parameters (e.g., geo-location, time of day, etc.). For example, in certain hospitality environments analysis platform 271 can identify and register a given audience category from the quantity and audience features (e.g., gait, posture, looking at a phone, walking a dog, is a tourist, etc.) to determine more detailed user information. In some embodiments, relevant information of certain objects can be determined by machine-learning techniques. For example, this can include applying a machine-learning algorithm to determine a nearby car's make/model, year, paint/trim package, etc. Such information can include time codes, location, etc. This information can be cross-referenced with, for example, as performed transactions (swiping a card, entering a code, etc.) to yet further refine the information about users/objects proximate to digital signage stand 9, thus obtaining useful demographic compositions relevant to usage and control of digital signage stand 9.

In some embodiments, the sensing component can include a light sensor and the digital signage stand can be configured to change content 8 based on an ambient light level at the digital signage stand.

The changing or displaying of content 8 executed by processor 20 based on the analysis results can be obtained through comparisons and calculations in a database and/or by including artificial intelligence technology. In practice, this can be realized by connecting the processor 20 to a cloud database or cloud computing platform, or through the previously mentioned wireless transmission component 24.

In some embodiments, by incorporating elements disclosed herein, the operations can include determining a location of the digital signage stand, determining the composition of users proximate to the sensing component, the composition including identifying information for one or more of the users, transmitting the composition to a remote platform that analyzes the composition, receiving display instructions from the remote platform based on the analyzed composition, and displaying, at the display component, the content based at least on the display instructions.

Digital signage stand 9 can incorporate advanced hardware and software. In some embodiments, digital signage stand 9 can combine the display format of a movable (battery-powered) commercial menu-board kiosk with real-time profile access and update control features of a network embedded system (e.g. ATM, point-of-sale). Digital signage stand 9 can be, for example, a wheeled cabinet (or floor-standing, wall-mount, etc.) that is durable, weather-proof, and shatter-resistant.

In some embodiments, display component 21 can include a built-in screen (e.g. 50″ LCD panel connected to the motherboard by LVDS cable) that can play full video from high-definition sources (or better, e.g. 4K) at variable brightness in the 2,500-7,000 nits range behind a protective layer of tempered glass, as well as providing corresponding sound. In some embodiments, the same screen can be a touch-screen for interactivity with the programmed content.

In some embodiments, motherboard architecture can include a power-saving ARM A17 Cortex microprocessor with extensions for a thermal-control fan system, USB and serial-bus peripherals. 2.4 GHz wi-fi and/or LTE connectivity can be provided, as well as optionally short-range wireless. The onboard processors can include the instruction set of a comparable tablet or embedded computer, with enough storage (e.g., at least 2 GB RAM, 32 GB on-board flash memory) to run multiple background applications in addition to the main display player, sufficient to interface with a wide variety of back-end or remote-management agents over the Internet or a local network connection. In some embodiments, the motherboard's network stack can communicate with outside equipment (e.g., card readers, audience smart phones/ear buds, or physically separate signage equipment) for synchronized or overlapping layouts of content 8.

In some embodiments, a stationary webcam peripheral can create snapshots for either local storage and processing or uploading to a remote (cloud) platform for analysis. In some embodiments, DVR streams can be relayed as well. Additional sensors such as microphone and infrared can be added to this architecture. Two or more sensors can gather coordinated metadata for enhancing interactivity and location/time/traffic profile, ultimately to enable more elastic content programming.

In some embodiments, digital signage stand 9 can be configured for receiving updates from the back-end software dynamically, which assists fine-tuning the presentation on-site according to the operator's preference.

In some embodiments, e.g., a wheeled-cabinet version of digital signage stand 9, a case can fit alongside or in lieu of existing site equipment. Compartments can be added to accommodate non-digital equipment such as cash drawers, key racks, and umbrellas segregated from display component 21. Such embodiments can follow a turnkey solution extensible to pre-existing systems (e.g., a card reader or ticketing or inventory system) or providing integration to a simplified control app for an operator's basic configuration of the display mode). For example, the charging method can include a connection to an AC outlet with status lights to indicate charging-and can relay the operational info back to a user (e.g., battery level, downloading updates, downtime announcements) regardless of a technician's presence. In some embodiments, this can include having a charging cord with active monitoring. For example, the input connector for the power supply component 22 can include a responsive status light. The responsive status light can be, for example, a colored LED ring around the connector or a discreet indicator light adjacent to the connector, optionally under a cover such as a water-resistant silicone flap.

The responsive status light can confirm the electrical current draw of the internal power conversion system and provide an operator with visual feedback of the charging state. Internal metrics of charging, e.g. voltage, battery temperature, cycle length, can be assessed by software on processor 20. This measurement can be conducted with or without the CPU and mainboard being powered on during charging (extrapolation from timestamps). In some embodiments, when the mainboard is activated and booted up, a voltmeter placed at the battery output (e.g., intermediate between exterior power socket/battery input and mainboard's DC power input from the battery) can transmit sensed data from the voltmeter for the charge state to the software on processor 21. This data can then be relayed to the operator, optionally in simplified form, for example through a notification or a status page on a web site or app tab.

In some embodiments, digital signage stand 9 can run a flexible architecture (e.g., ARM) to execute complex software operations. Types of identifying data the device could gather and analyze can include a number of people in front of a camera, time-stamped, with sufficient image resolution and multiple-capture/short-video to estimate demographic attributes and activity/impression markers (e.g. viewing the screen or not). Direct third-party interactions can be performed, such as ad-hoc wireless or scanning dynamically generated code on the display, or with equipment associated with the device (card readers, cash registers, ticketing system). The system can enable voice commands issued either by the operator or by third-party/audience invocation. Conditions outside the immediate foreground of the podium can be determined, e.g. street or sidewalk traffic patterns, unique mobile devices detected in the vicinity (via wi-fi radio), etc. The system can perform edge processing of the sensed data, such that it can interpret and massage the above pre-set data categories rather than transmit raw data to a potentially overloaded server. Particularly when there are a large number of digital signage stands 9, this can facilitate scalability.

In communication with remote platform 3, other features that can be present in various embodiments can include coordination with external databases for biometric ID (e.g., face, voice, etc.), image sharpening or other modification treatment of webcam video; and forwarding of raw inputs to neural nets for classification or storage to large external datasets (logs and images) to adduce latent demographic or consumer trends in evidence around the given digital signage stand 9.

In some embodiments, the software of the device can be controllable remotely through a management portal, up to and including a live screen view of each, thus offering insight into the content presentation and responsiveness to operator needs.

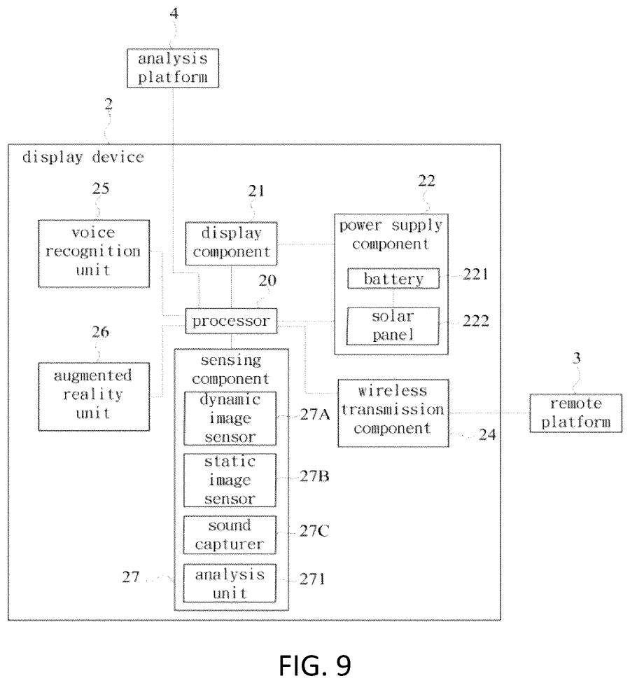

FIG. 9 is a block diagram for a seventh embodiment of the digital signage stand. In this disclosure, processor 20 of display device 2 can be additionally connected to analysis platform 4 via telecommunication. This connection facilitates the transmission of user information to analysis platform 4, allowing it to analyze the user information to generate an engagement result. Unlike the previous embodiments, this highlights that processor 20 can obtain the engagement result with analysis platform 4. By analyzing user information, analysis platform 4 can interpret the level of user engagement with content 8 displayed by display component 21. User engagement includes factors such as the duration of interaction and the level of interactivity between users and display device 2.

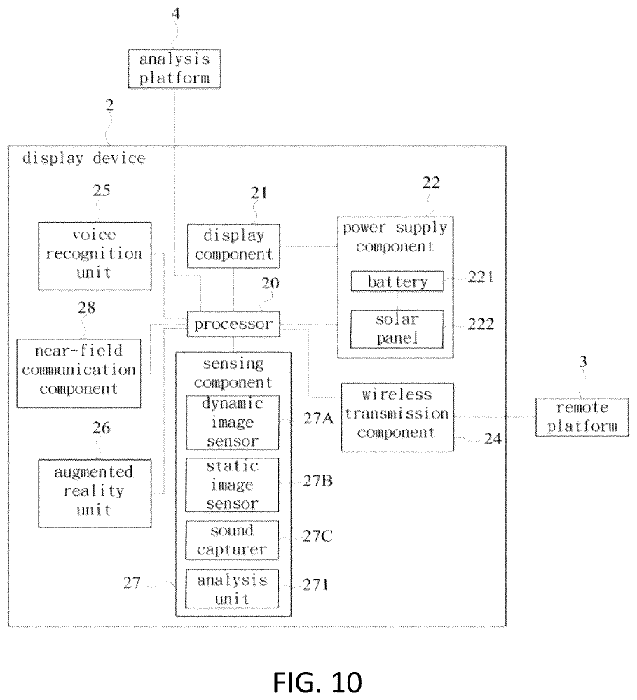

FIG. 10 is a block diagram for an eighth embodiment of the digital signage stand. Display device 2 can include a near-field communication component 28, which can be connected to processor 20 for telecommunication. Near-field communication component 28 can be, for example, configured for operation in NFC or RFID communication formats. This can allow real-time exchange of various information between a user and display device 2, such as content data and owner information. In some embodiments, near-field communication component 28 can be of a modular design (e.g., a removable peripheral), providing flexibility in configuration.

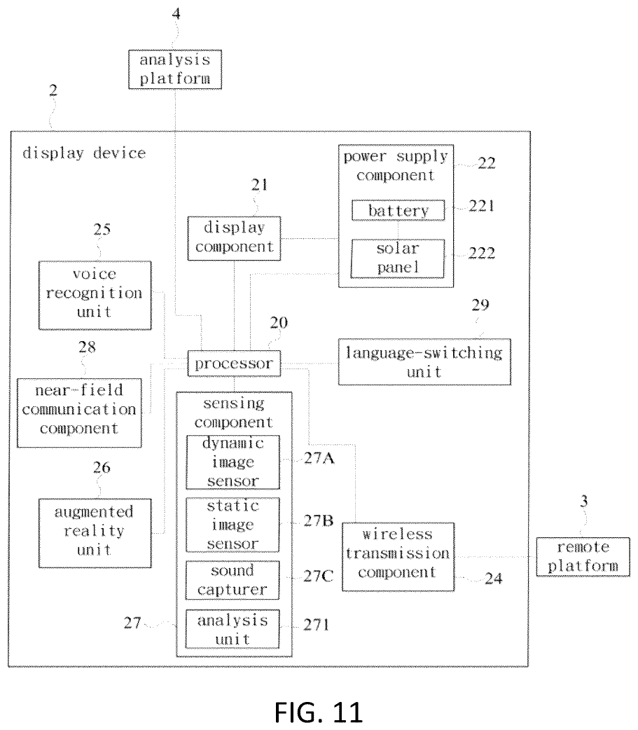

FIG. 11 is a block diagram for a ninth embodiment of the digital signage stand. Display device 2 can include language-switching unit 29, which can be connected to processor 20 for telecommunication. Language-switching unit 29 can switch the language of the content 8 or a functional interface of display device 2 to be manually switched. This can allow display device 2 to switch to the corresponding language based on user preferences, such as for voice broadcasts or language displays of content in various languages or adjusting the language category of the functional interface menu based on a user's requirements.

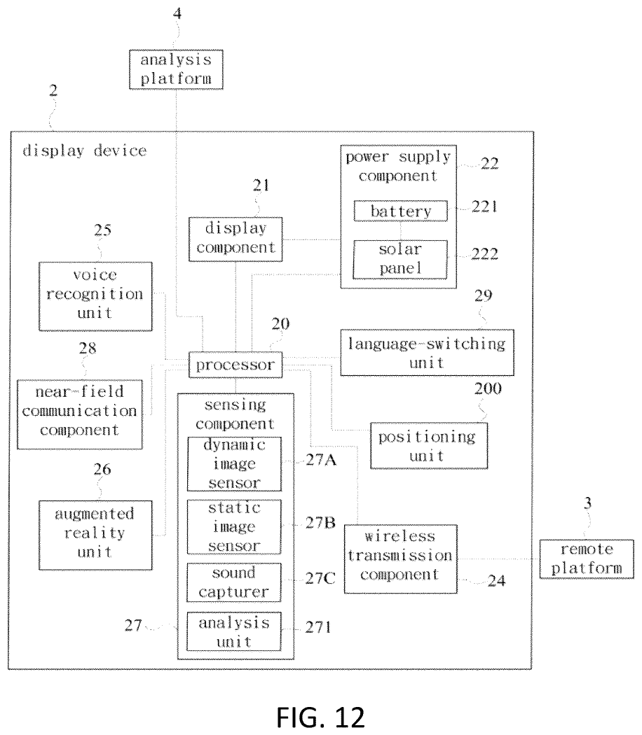

FIG. 12 is a block diagram for a tenth embodiment of the digital signage stand. Digital signage stand 9 can include and integrated with display device 2, language-switching unit 29 along with positioning unit 200. Language-switching unit 29 and positioning unit 200 can be in electronic communication with processor 20. The language of content 8 or the functional interface of display device 2 can be switched based on settings or geographical location. In addition to manual language switching, automatic language switching based on the geographical location of digital signage stand 9 can be achieved through the positioning unit 200. For example, when digital signage stand 9 is located in Japan, the positioning unit 200 can detect the geographical location of the digital signage stand 9 and instruct language-switching unit 29 to switch to Japanese mode. This enables the display of content 8 in Japanese audio and/or text and the display of the functional menu interface in Japanese for local manager operation. Thus, regardless of the location, the language used in the original (e.g., default) content 8, or the application area of the digital signage stand 9, the display language of content 8 can be automatically switched based on the installation location of the digital signage stand 9.

In some embodiments, an instruction to change content 8 can be based on a time. For example, in some embodiments, the digital signage stand can include positioning unit 200 with processor 20 configured to generate (e.g., determine) a location (e.g., a geographic location such as GPS coordinates, city, country, etc.) of the digital signage stand. The instruction can then be based on the location of the digital signage stand. In some embodiments, a time at the location of the digital signage stand can be determined and the instruction can also be generated based at least on the time. For example, changing content at location X can occur at time(s) T1, T2, T3, etc. and changing at location Y can occur at times T4 and T5.

Since many modifications, variations, and changes in detail can be made to the described embodiments, it is intended that all matters in the foregoing description and shown in the accompanying drawings be interpreted as examples.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship with each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the following, further features, characteristics, and exemplary technical solutions of the present disclosure will be described in terms of clauses that may be optionally claimed in any combination:

Clause 1. A digital signage stand comprising: a main body including a display area outwardly oriented; and a display device positioned on the stand main body and including: a processor; a display component connected to the processor and positioned within the display area; a non-transitory machine-readable medium storing instructions which, when executed by the processor, cause the processor to perform operations comprising: receiving, without user input, an instruction to change content displayed at the display component; and changing the content displayed at the display component based on the instruction; and a power supply component, electrically connected to the display component and the processor.

Clause 2. The digital signage stand of clause 1, wherein the digital signage stand is configured as a parking valet stand, the main body comprising an upright desk with a tabletop.

Clause 3. The digital signage stand of any of the preceding clauses, wherein the display component comprises a display panel and a touch panel, the touch panel overlaying the display panel.

Clause 4. The digital signage stand of any of the preceding clauses, wherein the display component further comprises a heat-insulating component positioned between the touch panel and the display panel.

Clause 5. The digital signage stand of any of the preceding clauses, wherein the touch panel comprises a touch function substrate and a protective cover, the protective cover overlaying the touch function substrate.

Clause 6. The digital signage stand of any of the preceding clauses, wherein the touch panel utilizes capacitive touch technology, and screen resolution of the display panel is 4K or higher.

Clause 7. The digital signage stand of any of the preceding clauses, wherein the display device includes a frame, and the frame is positioned around a periphery of the display component and is made of brushed aluminum material.

Clause 8. The digital signage stand of any of the preceding clauses, wherein the power supply component comprises a battery.

Clause 9. The digital signage stand of any of the preceding clauses, wherein the power supply component further comprises a solar panel connected electrically to the battery.

Clause 10. The digital signage stand of any of the preceding clauses, wherein the display device additionally includes a wireless transmission component which is connected to the processor, the wireless transmission component utilizes Wi-Fi, Bluetooth, or Zigbee communication formats.

Clause 11. The digital signage stand of any of the preceding clauses, wherein the wireless transmission component is connected to a remote platform, and the remote platform allows the changing and/or managing of the content.

Clause 12. The digital signage stand of any of the preceding clauses, wherein the remote platform allows a user to remotely control or change the content displayed.

Clause 13. The digital signage stand of any of the preceding clauses, wherein the remote platform wirelessly communicates with one or more digital signage stands and allows a user to remotely control or change the content displayed on the one or more digital signage stands independently of each other.

Clause 14. The digital signage stand of any of the preceding clauses, wherein the display device further includes a near-field communication component which is connected to the processor.

Clause 15. The digital signage stand of any of the preceding clauses, wherein the display device further comprises a voice recognition unit which is connected to the processor, enabling voice recognition execution and generating corresponding commands for the processor.

Clause 16. The digital signage stand of any of the preceding clauses, wherein the display device additionally includes an augmented reality unit which is connected to the processor, wherein the augmented reality (AR) unit transmits instructions to augmented reality enabled devices to provide AR content related to the content as part of an augmented reality image.

Clause 17. The digital signage stand of any of the preceding clauses, wherein the instruction is based on a time.

Clause 18. The digital signage stand of any of the preceding clauses, further comprising a positioning unit, the operations further comprising generating of a location of the digital signage stand, wherein the instruction is based on the location of the digital signage stand.

Clause 19. The digital signage stand of any of the preceding clauses, the operations further comprising: determining a time at the location of the digital signage stand; and generating the instruction based at least on the time.

Clause 20. The digital signage stand of any of the preceding clauses, wherein the display device further comprises a sensing component which is connected to the processor.

Clause 21. The digital signage stand of any of the preceding clauses, wherein the sensing component includes one or a combination of a dynamic image sensor, a static image sensor, and a sound capturer.

Clause 22. The digital signage stand of any of the preceding clauses, wherein the sensing component includes an analysis unit for analyzing user information, the operations further comprising: generating user information based on sensed data obtained from the sensing component; obtaining an analysis result from an analysis unit analyzing the user information; and dynamically adjusting the content displayed by the display component based on the analysis result.

Clause 23. The digital signage stand of any of the preceding clauses, the operations further comprising determining, from at least the sensed data, the user information that includes a dwell time based on a duration of detection and a proximity to the digital signage stand of the user.

Clause 24. The digital signage stand of any of the preceding clauses, the operations further comprising: determining dwell times for a plurality of users; determining an average dwell time or a median dwell time based on the dwell times; and automatically changing the content at the display device when the average dwell time or the median dwell time is below a predetermine threshold dwell time.

Clause 25. The digital signage stand of any of the preceding clauses, wherein the processor of the display device is additionally connected to an analysis platform that analyzes user information to generate an engagement result.

Clause 26. The digital signage stand of any of the preceding clauses, the operations further comprising: generating modified sensed data with an onboard processor that in communication with the analysis unit; and causing transmission, via the onboard processor, the modified sensed data to a remote platform.

Clause 27. The digital signage stand of any of the preceding clauses, the operations further comprising: determining a location of the digital signage stand; determining a composition of users proximate to the sensing component, the composition including identifying information for one or more of the users; transmitting the composition to a remote platform that analyzes the composition; receiving display instructions from the remote platform based on the analyzed composition; and displaying, at the display component, the content based at least on the display instructions.

Clause 28. The digital signage stand of any of the preceding clauses, wherein the sensing component is a light sensor, and the operations further comprise changing the content based on an ambient light level at the digital signage stand.

Clause 29. The digital signage stand of any of the preceding clauses, wherein the display device further includes a language-switching unit which is connected to the processor, the language-switching unit enables the language of the content or the functional interface of the display device to be manually switched.

Clause 30. The digital signage stand of any of the preceding clauses, wherein the display device further includes a language-switching unit and a positioning unit, the language-switching unit and the positioning unit are respectively connected to the processor via telecommunication, allowing the language of the content or the functional interface language of the display device to be switched based on manual switching or geographical location of the digital signage stand.

What is claimed is:

1. A digital signage stand comprising:
a main body including a display area outwardly oriented; and
a display device positioned on the stand main body and including:
a processor;
a display component connected to the processor and positioned within the display area;
a non-transitory machine-readable medium storing instructions which, when executed by the processor, cause the processor to perform operations comprising:
receiving, without user input, an instruction to change content displayed at the display component; and
changing the content displayed at the display component based on the instruction; and
a power supply component, electrically connected to the display component and the processor.

2. The digital signage stand of claim 1, wherein the digital signage stand is configured as a parking valet stand, the main body comprising an upright desk with a tabletop.

3. The digital signage stand of claim 1, wherein the display component comprises a display panel and a touch panel, the touch panel overlaying the display panel.

4. The digital signage stand of claim 3, wherein the display component further comprises a heat-insulating component positioned between the touch panel and the display panel.

5. The digital signage stand of claim 3, wherein the touch panel comprises a touch function substrate and a protective cover, the protective cover overlaying the touch function substrate.

6. The digital signage stand of claim 3, wherein the touch panel utilizes capacitive touch technology, and screen resolution of the display panel is 4K or higher.

7. The digital signage stand of claim 1, wherein the display device includes a frame, and the frame is positioned around a periphery of the display component and is made of brushed aluminum material.

8. The digital signage stand of claim 1, wherein the power supply component comprises a battery.

9. The digital signage stand of claim 8, wherein the power supply component further comprises a solar panel connected electrically to the battery.

10. The digital signage stand of claim 1, wherein the display device additionally includes a wireless transmission component which is connected to the processor, and the wireless transmission component utilizes Wi-Fi, Bluetooth, or Zigbee communication formats.

11. The digital signage stand of claim 10, wherein the wireless transmission component is connected to a remote platform, and the remote platform allows the changing and/or managing of the content.

12. The digital signage stand of claim 11, wherein the remote platform allows a user to remotely control or change the content displayed.

13. The digital signage stand of claim 11, wherein the remote platform wirelessly communicates with one or more digital signage stands and allows a user to remotely control or change the content displayed on the one or more digital signage stands independently of each other.

14. The digital signage stand of claim 1, wherein the display device further includes a near-field communication component which is connected to the processor.

15. The digital signage stand of claim 1, wherein the display device further comprises a voice recognition unit which is connected to the processor, enabling voice recognition execution and generating corresponding commands for the processor.

16. The digital signage stand of claim 1, wherein the display device additionally includes an augmented reality unit which is connected to the processor, wherein the augmented reality (AR) unit transmits instructions to augmented reality enabled devices to provide AR content related to the content as part of an augmented reality image.

17. The digital signage stand of claim 1, wherein the instruction is based on a time.

18. The digital signage stand of claim 1, further comprising a positioning unit, the operations further comprising generating of a location of the digital signage stand, wherein the instruction is based on the location of the digital signage stand.

19. The digital signage stand of claim 18, the operations further comprising:
determining a time at the location of the digital signage stand; and
generating the instruction based at least on the time.

20. The digital signage stand of claim 1, wherein the display device further comprises a sensing component which is connected to the processor.

21. The digital signage stand of claim 20, wherein the sensing component includes one or a combination of a dynamic image sensor, a static image sensor, and a sound capturer.

22. The digital signage stand of claim 20, wherein the sensing component includes an analysis unit for analyzing user information, the operations further comprising:
generating user information based on sensed data obtained from the sensing component;
obtaining an analysis result from an analysis unit analyzing the user information; and
dynamically adjusting the content displayed by the display component based on the analysis result.

23. The digital signage stand of claim 22, the operations further comprising determining, from at least the sensed data, the user information that includes a dwell time based on a duration of detection and a proximity to the digital signage stand of the user.

24. The digital signage stand of claim 22, the operations further comprising:
determining dwell times for a plurality of users;
determining an average dwell time or a median dwell time based on the dwell times; and
automatically changing the content at the display device when the average dwell time or the median dwell time is below a predetermined threshold dwell time.

25. The digital signage stand of claim 20, wherein the processor of the display device is additionally connected to an analysis platform that analyzes user information to generate an engagement result.

26. The digital signage stand of claim 20, the operations further comprising:
generating modified sensed data with an onboard processor that in communication with the analysis unit; and
causing transmission, via the onboard processor, of the modified sensed data to a remote platform.

27. The digital signage stand of claim 20, the operations further comprising:
determining a location of the digital signage stand;
determining a composition of users proximate to the sensing component, the composition including identifying information for one or more of the users;
transmitting the composition to a remote platform that analyzes the composition;
receiving display instructions from the remote platform based on the analyzed composition; and
displaying, at the display component, the content based at least on the display instructions.

28. The digital signage stand of claim 20, wherein the sensing component is a light sensor and the operations further comprise changing the content based on an ambient light level at the digital signage stand.

29. The digital signage stand of claim 1, wherein the display device further includes a language-switching unit which is connected to the processor, the language-switching unit enables the language of the content or the functional interface of the display device to be manually switched.

30. The digital signage stand of claim 1, wherein the display device further includes a language-switching unit and a positioning unit, the language-switching unit and the positioning unit are respectively connected to the processor via telecommunication, allowing the language of the content or the functional interface language of the display device to be switched based on manual switching or geographical location of the digital signage stand.
